(19) United States
(12) Patent Application Publication
(10) Pub. No.: US 2012/0296614 A1
(43) Pub. Date: Nov. 22, 2012

(54) METHOD FOR SETTING FUNCTION PARAMETERS

(76) Inventors: Martin Johannaber, Schwieberdingen (DE); Maximilian Reger, Stuttgart (DE)

(21) Appl. No.: 13/510,058

(22) PCT Filed: Dec. 2, 2010
(86) PCT No.: PCT/EP10/68748

§ 371 Date: Aug. 3, 2012

(30) Foreign Application Priority Data
Dec. 17, 2009 (DE) 10 2009 054 902.1

(51) Int. Cl. G06G 7/48

(52) U.S. Cl. 703/8

(57) ABSTRACT

A method for setting function parameters of a control unit for a motor vehicle, in which at least one target variable is predefined in a weighting characteristics map, the target variables representing a behavior of the motor vehicle, and an assignment to a model of optimum parameters being provided in the weighting characteristics map so that predefined target variables are assigned to a set of optimum parameters which are set as the function parameters.

### FIELD OF THE INVENTION

The present invention relates to a method for setting function parameters of a control unit and to a control unit of this type, as well as to a method for calculating a model of optimum parameters.

### BACKGROUND INFORMATION

Control units are used to control injection systems for internal combustion engines in motor vehicles. In these control units, it is provided that control unit functions are designed according to requirements, for example target variables and/or evaluation criteria, of the manufacturer and the end customer, using function parameters. Target variables relate to a desired behavior of the motor vehicle, for example with regard to driving comfort and dynamics. For example, time constants, amplification factors and trigger thresholds are used as function parameters for this purpose. The injection pressure, rail pressure, exhaust gas recirculation and valve setting are used as function parameters for the behavior with regard to, for example, emissions, performance and fuel consumption.

The complexity of the functions and thus also the number of function parameters increase along with rising demands on the injection system. At the same time, however, the customer demands simpler structures, since a complex software structure requires a great deal of expert knowledge to handle and is difficult to apply.

The aforementioned functions for a control unit offer the opportunity to determine at least one parameter set via constants, characteristic curves and characteristics maps, using fixed settings. However, the complexity of the functions and thus also the number of characteristics maps is increasing steadily. At best, function specialists know the influence of each parameter and are thus able to configure the functions according to the customer's requirements. The customer receives his desired compromise from a plurality of optimum, possible compromises. Possible deviations from the requirements may be compensated for by recurrences.

In the application of an engine control unit, the parameters for the control unit functions are ascertained according to the customer's requirements. However, target conflicts for which a compromise must be ascertained exist in many areas in the application of the functions. A system harmonization is ascertained which represents an optimum compromise between the competing target variables, since the targets may not be optimally achieved simultaneously. The compromise which best meets the project goals must therefore be found. The corresponding function parameters are usually permanently set in the control unit.

### SUMMARY

In accordance with the present invention, due to the use of a model of optimum parameters, a plurality of function parameters, characteristic curves and characteristics maps may be reduced to one or only a few operating point-dependent weighting characteristics maps. Operating points or operating variables are, for example, the gear selected, the rotational speed and the load. The complexity may thus be reduced for the customer or user even with an increasing complexity of the control unit functions. The application is carried out as a predefinition of the target variables/target criteria or their weightings. As a result, the user does not have to be a function specialist to implement the desired requirements for the system. He does not even need to know the function parameters.

The use of the model of optimum parameters with at least one weighting characteristics map in the control unit also makes it possible to implement different settings or setups or configurations via differently configured weighting characteristics maps which are stored in the control unit, without having to duplicate the basic characteristics maps of the control unit functions.

For example, it is possible to store a sporty vehicle performance, on the one hand, and a comfortable vehicle performance, on the other hand, as a harmonization between two different weighting characteristics maps. In addition, weighting characteristics maps may be stored either for a consumption-optimized or a performance-optimized configuration.

A direct regulation to the weighting factors of the model of optimum parameters is also conceivable. If setpoint values of target variables and/or criteria are not achieved, this circumstance may be continuously adjusted by changing the weightings with the aid of a regulation function.

The present invention permits an application by directly predefining objective target variables and/or criteria for a function in the control unit. The fact that the technical requirements and complexity are increased internally in the application as well as for the customer by the steady increase in the complexity of software structures is taken into account thereby.

The use of the model of optimum parameters with at least one weighting characteristics map in the control unit makes it possible to vary and predefine the system behavior directly via the target variables or evaluation criteria or via their weightings. For users, this approach may reduce a plurality of function parameters, function characteristic curves and/or characteristics maps to one or just a few operating point-dependent weighting characteristics maps.

The present invention typically ensures that an application is possible by setting target variables. The concentration is used for a task or requirement and not for the function parameters. The complexity may thus be reduced for the user. In addition, a function specialist is not needed for adjusting function parameters. A systematic procedure may be carried out by objectively evaluating the settings. Recurrences for adapting the requirements are also less complex.

The present invention furthermore permits a system having multiple competing target variables to be regulated by continuous shifting of the weightings of target variables. Due to the model of optimum parameters, this means that optimum function parameters are always available for the system in the control unit. In one specific embodiment of the present invention, a control loop which regulates the system behavior with regard to multiple competing target variables as a possible manipulated variable may be closed around this model and the system to be regulated. A complex, nonlinear multi-variable system may thus be regulated to target variables as a function of the operating mode.

The weighting is shifted regularly via a manipulated variable. The control loop is closed via the model of optimum parameters. Furthermore, only function parameters which represent an optimum achievement of the present target compromise are typically set with the aid of the model of optimum parameters.

Due to the present invention described, it is possible to adapt the conventional permanently set function parameters as a function of external influences, for example the operating state. The system behavior may thus be adapted to the particular operating state or the course of the operating state by varying control and regulating parameters.

Due to the model of optimum parameters, a complex system of target compromises may be optimally controlled and regulated. An external control loop changes only weighting criteria and thus changes the compromise between different target criteria. This takes place via the model of optimum parameters, which varies different parameters of the control units in such a way that the system may always be optimally operated with regard to the target criteria. For example, control and regulating parameters of the engine control functions are continuously adjusted during operation via the model of optimum parameters.

In one embodiment, a response to the load profile may be made and the harmonization of the engine controller may be varied in an engine controller of a motor vehicle.

Further advantages and embodiments of the present invention are described below with reference to the figures.

It is understood that the aforementioned features and the features still to be explained below may be used not only in the particular specified combination but also in other combinations or alone without going beyond the scope of the present invention.

### BRIEF DESCRIPTION OF THE DRAWINGS

FIG. 1 shows a schematic representation of a possible embodiment of the method for setting function parameters.

FIG. 2 shows a regulation system having a model of optimum parameters and a control loop.

FIG. 3 shows a regulation system having a model of optimum parameters for engine control.

### DETAILED DESCRIPTION OF EXAMPLE EMBODIMENTS

The present invention is represented schematically in the figures on the basis of specific embodiments and is described in greater detail below.

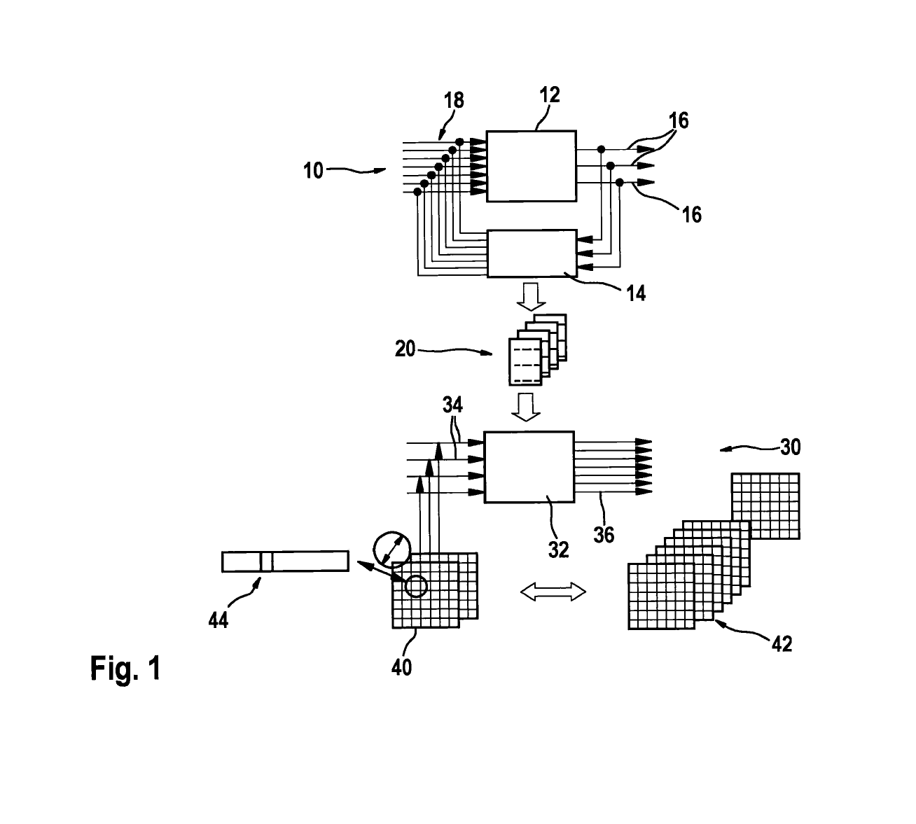

FIG. 1 illustrates the procedure involved in the presented example method for setting function parameters. A model of optimum parameters P₁ through Pₙ, which is available in the control unit, is provided with weighting characteristics maps for target variables Z₁ through Zₙ and/or criteria K₁ through Kₙ.

In a first step 10, a multi-target optimization is carried out in advance on all necessary target variables and/or criteria (arrows 16) having the available function parameters (arrows 18), using a system or a model 12 over all necessary operating points BPₙ with the aid of an optimizer 14.

The results obtained from the optimization then include the optimized function parameters for all compromises of the target variables and/or criteria (second step 20) for each operating point.

In a third step 30, an operating point-dependent model of optimum parameters 32 may then be generated from the results obtained in the optimization. This model may be generated in the form of characteristics maps, multidimensional data models or lists of optimum parameters. The model inputs are the operating points and the target variables and/or criteria or their weighting and thus the weighting of target variables/criteria GZ₁/GK₁ through GZₙ/GKₙ (arrows 34) itself, and the outputs thereof are corresponding optimum parameters P₁ₒₚₜ through Pₙₒₚₜ (arrows 36).

By storing this model of optimum parameters 32 in the control unit, the desired weighting of the target variables may be predefined via an operating point-dependent characteristics map, and the target variables output the optimum parameters in this operating point as inputs of the model for optimum parameters 32 and are then available in the control unit function. The weighting characteristics map may include a field or an array of the weightings of all target variables and/or criteria, for example for each operating point, after which, one or two operating point-dependent weighting characteristics maps 40 may be available as needed. One weighting characteristics map for each target variable may furthermore be used. N operating point-dependent functional characteristics maps 42 are then available.

More than two operating points may result in more than one weighting characteristics map of the function. Normalized, the sum of the weightings results in 1.

Due to the model, all optimum parameter combinations are stored in the control unit. The weightings of the target variables may be adjusted to change the application strategy. This results in optimum function parameters without necessarily having to know the function parameters. For example, the weightings may also be continuously modified with the aid of one or multiple sliders 44 as a man/machine interface, thereby setting the desired harmonization.

It is furthermore possible to generate different variants with the aid of multiple weighting characteristics maps of the target variables. The switchover between the harmonizations and weighting characteristics maps may be carried out with the aid of a finite state machine in the control unit software or by the driver himself (knob, slider, menu on the display).

The model and the weighting characteristics map may be used to simplify the configuration of the function for the user by reducing a plurality of function parameters, characteristic curves or characteristics maps to one or just a few weighting characteristics maps.

The model includes all optimum parameters of all compromises of the target variables and/or criteria for all necessary operating points. It is also possible to dispense with the function characteristic curves/characteristics maps.

Alternatively, the model of optimum parameters having a weighting characteristics map may also be calculated outside the control unit software, and the settings may thus be transmitted to the test carrier via a tool having an interface to the control unit. The harmonization results are then immediately available in the control unit or must be transferred to the control unit after the harmonization. This has the advantage that the control unit software does not have to be modified.

However, it should be noted that, as the case may be, different setups or regulations cannot be implemented in the weightings. An additional tool must be available for the application and also for the customer. It is therefore not possible to subsequently measure whether or not the harmonization was carried out in this way.

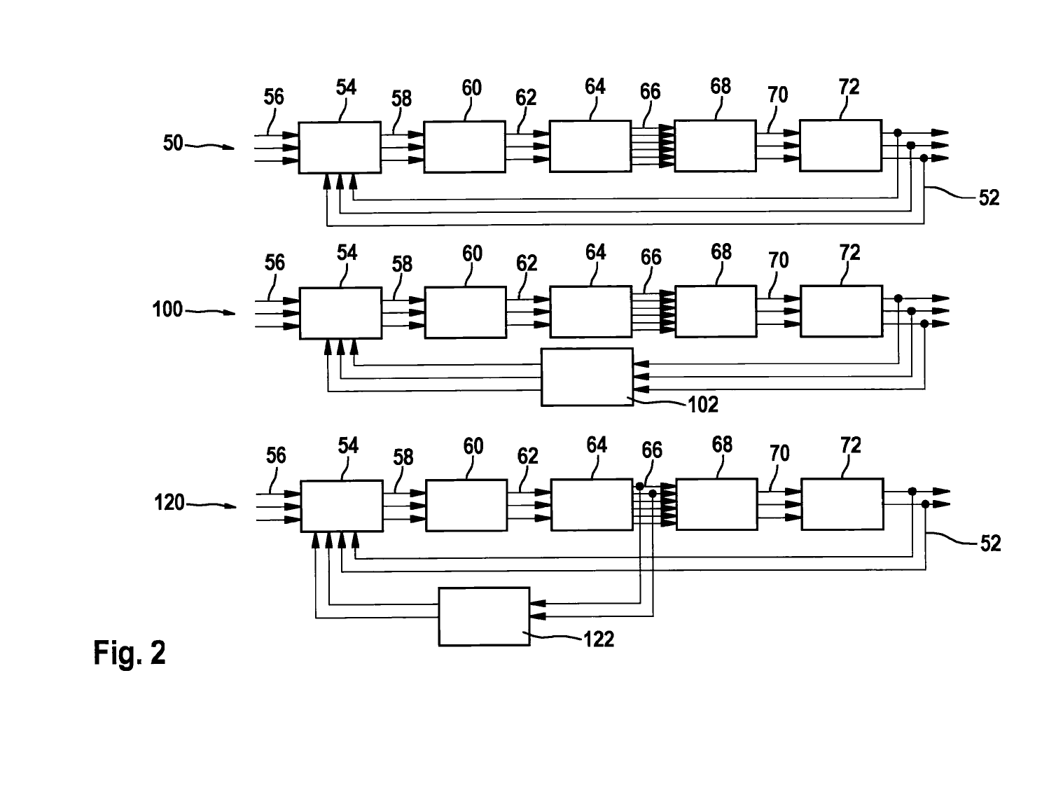

FIG. 2 shows different options for regulating the system with regard to multiple target variables, using the model of optimum parameters and a control loop. In all cases, the model of optimum parameters (MoP) and the controller are situated upstream from a control unit function.

In first case 50, a setpoint/actual value comparison (block 54) having predefined values Z₁ₛₑₜₚₒᵢₙₜ through Zₙₛₑₜₚₒᵢₙₜ (arrows 56) is carried out on the basis of measured variables Z_{1actual} through Z_{nactual} (arrows 52), and control deviation e₁ through eₙ (arrows 58) is determined. A desired behavior of the system may be predefined via setpoint/actual value comparison 52 and controlled via a controller 60. This results in weightings G₁ through Gₙ (arrows 62), which are entered into a model of optimum parameters 64, which, in turn, outputs a set of optimum parameters P₁ through Pₙ (arrows 66). These parameters are entered into control unit functions 68, so that signals S₁ through Sₙ (arrows 70) are generated which are entered into a system 72. The system outputs variables Z_{1actual} through Z_{nactual}, which, in turn, are the measured variables (arrow 52).

In a second case, setpoint/actual comparison 54 is not carried out directly using the measured variables but rather calculated from these target variables or criteria (block 102). These target variables must clearly describe the system behavior. In second case 100, the target functions may depend not only on the instantaneous value of the measured variables, but instead the operating mode and the system behavior in the past may also be taken into account. Due to the setpoint predefinition, the system behavior may be regulated to the setpoint value of the target function with the aid of controller 60 and the model of optimum parameters 64.

In a third case 120, the output variables of system 72 are not measured, but instead they are calculated via a model 122 to determine these variables. In the illustrated case, model 122 is used which maps the system behavior with the aid of the control unit parameters and system input variables and thus supplies virtual measured values.

An example for using a model of optimum parameters and a regulating system is the regulation of harmful substance emissions and carbon dioxide emissions. Using the combination of ideal control parameters and a regulation of the criteria weighting presented herein, the supply of data to the control unit functions may be regulated for lower harmful substance emissions or less fuel consumption as a function of the driving profile. If the vehicle is operated, for example, using a load profile which is favorable for low emissions, the control unit parameters may be further regulated in the direction of low fuel consumption and vice versa. This regulation requires the competing targets of fuel consumption and harmful substance emissions to be either measured directly or calculated with sufficient accuracy with the aid of a model in the control unit.

By regulating the weighting of the targets and using the model of optimum parameters, it is possible, for example, to regulate to limiting values for emissions and to comply with limits for harmful substance emissions per kilometer not only within the certification cycle but also for each driving profile and thus to simultaneously achieve the minimum possible fuel consumption. Up to now, compliance with the exhaust gas limiting values has been checked only within the certification cycle and the engine control system optimized on this basis. This may result in higher consumption in operating points in which very few harmful substances are emitted and thus compliance with the limiting values would be problem-free. Consequently, the regulation described herein may be used not only to ensure compliance with the exhaust gas limiting values but also to reduce vehicle [fuel] consumption.

The approach may be transferred to many other functions in the engine control unit. It may also be transferred in a similar manner to control systems and regulating systems in other areas. The method requires the integration of a model of optimum parameters and the associated regulation of the weighting into the control unit. The method may be used for enhancements to the engine control unit software for any functions, and it may also be transferred to additional systems outside the control system for internal combustion engines.

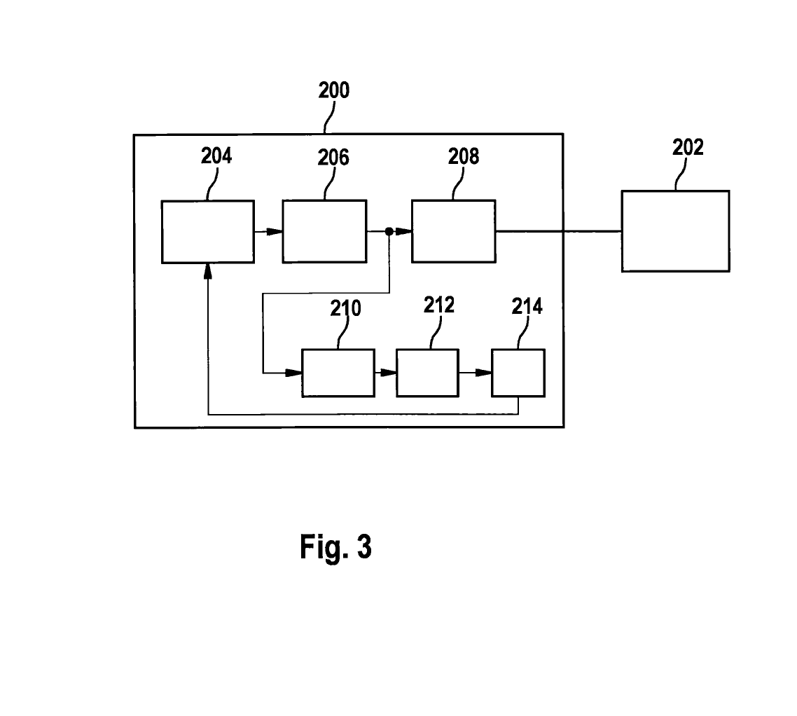

FIG. 3 shows a schematic representation of a control unit 200, in this case an engine control unit, which is used to activate an engine 202. A weighting characteristics map 204, a model of optimum parameters 206 and functions 208 are provided in control unit 200. A model for untreated emissions 210, a model for a catalytic converter 212 and a controller 214 are furthermore provided.

The weighting is predefined in weighting characteristics map 204. Optimum parameters from the model of optimum parameters 206 are ascertained herefrom. Functions 208 predefine signals for controlling engine 202 with the aid of these parameters.

In principle, it is possible to carry out a regulation on the basis of output variables measured directly at engine 202. If these output variables are unable to be easily ascertained, it is possible to enter the ascertained optimum parameters, for example, into the model for untreated emissions 210 and model 212 for the catalytic converter and to ascertain the desired output variables computationally. The variables ascertained in this way are then input variables of controller 214, which acts upon weighting characteristics map 204, in particular if certain thresholds of individual variables are exceeded.

1-9. (canceled)

10. A method for setting function parameters of a control unit for a motor vehicle, comprising:
predefining at least one target variable in at least one weighting characteristics map, the at least one target variable representing a behavior of the motor vehicle, and an assignment to a model of optimum parameters being provided in the at least one weighting characteristics map so that at least one predefined target variable is assigned to a set of optimum parameters which are set as the function parameters, at least two target variables being predefined in the at least one weighting characteristics map;
wherein the model of optimum parameters includes all optimum parameters of all compromises of the target variables at all necessary operating points.

11. The method as recited in claim 10, further comprising:
carrying out a regulation by continuously shifting a weighting of the at least one target variable.

12. The method as recited in claim 11, wherein the regulation is carried out via a manipulated variable.

13. A control unit for a motor vehicle, the control unit including a memory unit in which a model of optimum parameters is stored, the model of optimum parameters including all optimum parameters of all compromises of target variables at all necessary operating points.

14. The control unit as recited in claim 13, further comprising:
a man/machine interface via which the optimum parameters from the model of optimum parameters are to be predefined with the aid of a weighting characteristics map.

15. A method for calculating a model of optimum parameters, comprising:
assigning target variables to parameter sets which are used to achieve the target variables, the model of optimum parameters including all optimum parameters of all compromises of the target variables at all necessary operating points.

16. The method as recited in claim 15, wherein the model of optimum parameters is calculated within control unit software.

17. The method as recited in claim 15, wherein the model of optimum parameters is calculated outside control unit software.

18. The method as recited in claim 15, wherein the model of optimum parameters is calculated with the aid of an optimizer.
